(19) United States
(12) Patent Application Publication
(10) Pub. No.: US 2006/0106538 A1
(43) Pub. Date: May 18, 2006

(54) Cooperative collision mitigation

(76) Inventors: Alan L. Browne, Grosse Pointe, MI (US); Osman D. Altan, Northville, MI (US); Hariharan Krishnan, Troy, MI (US); Scott P. Geisler, Clarkston, MI (US); Francis D. Wood, Detroit, MI (US)

Correspondence Address: KATHRYN A MARRA;General Motors Corporation, Legal Staff, Mail Code 482-C23-B21, P.O.Box 300, Detroit, MI, 48265-3000, US

(21) Appl. No.: 10/987,461

(22) Filed: Nov. 12, 2004

(51) Int. Cl. G08G 1/16

(52) U.S. Cl. 701/301

(57) ABSTRACT

A method of predicting severity of a potential collision of a vehicle and an object. The method includes determining a probability of the potential collision. An elicitation signal is directed and transmitted to the object from the vehicle when the probability of the potential collision is greater than a threshold value. A response signal is received onboard the vehicle from a device situated on the object in response to the elicitation signal. The response signal includes a type associated with the object. A severity level of the potential collision is predicted based on the type.

### TECHNICAL FIELD

The present invention relates to features in a vehicle for identifying objects and, more particularly, to a system for positively identifying the type of an object, assessing the relationship between the object and the vehicle, and deploying vehicle responsive devices according to certain situations.

### BACKGROUND OF THE INVENTION

Examples of typical vehicle responsive devices include inflatable air bag systems, seat belt systems with pyrotechnic pretensioners, bumper systems, knee bolster systems and the like. These systems can be resettable, meaning that deployment does not affect their continued operability, and non-resettable, meaning that once deployed, replacement is necessary. Vehicle responsive devices that require activation or deployment are generally triggered by, and thus during, an actual physical impact event itself. That is, many vehicles utilize deploy systems that include impact sensors which are sensitive to abrupt changes in vehicle inertia or momentum, such as, for example, coil spring sensors, magnet-and-ball sensors, or micro-electro-mechanical systems (MEMS) devices including capacitive and/or piezoresistive accelerometer sensors, to activate or deploy vehicle responsive devices.

Predictive collision sensing systems include multiple line-of-sight sensors that sense the close-range position and relative velocity of an object that is within a particular distance from the sensor. Such sensors can be utilized, for example, to activate a braking system and/or to pre-arm an airbag system just prior to a collision impact. In making the actual decision to activate and/or pre-arm such vehicle responsive devices, the position and velocity of the object relative to the vehicle, as determined by the system sensors may be utilized. A short coming of such a system is that a prediction of the severity of an imminent collision based only upon the relative position and velocity of the object, without identifying the nature of the object itself, can be inaccurate.

### BRIEF DESCRIPTION OF THE INVENTION

One aspect of the invention is a method of predicting severity of a potential collision of a vehicle and an object. The method includes determining a probability of the potential collision. An elicitation signal is directed and transmitted to the object from the vehicle when the probability of the potential collision is greater than a threshold value. A response signal is received onboard the vehicle from a device situated on the object in response to the elicitation signal. The response signal includes a type associated with the object. A severity level of the potential collision is predicted based on the type.

Another aspect of the invention is a method of predicting severity of a potential collision of a vehicle and an object. The method includes determining a probability of the potential collision. An electromagnetic radio-frequency communication linkage is established between at least one global positioning system satellite and a global positioning system device onboard the vehicle to obtain real time vehicle position data from the satellite for use onboard the vehicle when the probability of the potential collision is greater than a threshold value. A sensor is utilized to obtain real time object position data regarding the real time position of the object with respect to the vehicle. The real time vehicle position data and the real time object position data are utilized to determine whether digital map data accessed by the global positioning system device provides information positively identifying the type of the object. A severity level of the potential collision is predicted in response to the global positioning system positively identifying the type of the object with input to the predicting including the type.

Another aspect of the invention is a computer program product for predicting severity of a potential collision of a vehicle and an object. The computer program product includes a storage medium readable by a processing circuit and storing instructions for execution by the processing circuit for performing a method. The method includes determining a probability of the potential collision. An elicitation signal is directed and transmitted to the object from the vehicle when the probability of the potential collision is greater than a threshold value. A response signal is received onboard the vehicle from a device situated on the object in response to the elicitation signal. The response signal includes a type associated with the object. A severity level of the potential collision is predicted based on the type.

A further aspect of the invention is an apparatus for predicting severity of a potential collision of a vehicle and an object. The apparatus includes a transmitter and a receiver. The apparatus also includes a microprocessor in communication with the transmitter and the receiver, and the microprocessor includes instructions to implement a method. The method includes determining a probability of the potential collision. An elicitation signal is directed and transmitted to the object from the vehicle, via the transmitter, when the probability of the potential collision is greater than a threshold value. A response signal is received, via the receiver, onboard the vehicle from a device situated on the object in response to the elicitation signal. The response signal includes a type associated with the object. A severity level of the potential collision is predicted based on the type.

### BRIEF DESCRIPTION OF THE DRAWINGS

Referring to the exemplary drawings wherein like elements are numbered alike in the several FIGURES:

FIG. 1 is a block diagram of a basic hardware system, according to the present invention, for deploying responsive devices in a vehicle in anticipation of a potential collision with an object;

FIG. 2 is an illustration of a vehicle having the system of FIG. 1 onboard, wherein the vehicle faces potential collisions with a first object, for example, a street lamp post having a transponder, and a second object, for example, a tree having a reflector;

FIG. 3 is a flow diagram of a basic method, according to an exemplary embodiment of the present invention, for deploying responsive devices in a vehicle in anticipation of a collision with an object, wherein the method is implementable with the system of FIG. 1;

FIG. 4 is a graph illustrating the half-power frequency bandwidth of an elicitation signal transmitted from a wideband radio-frequency transmitter that may be included in the system of FIG. 1;

FIG. 5 is a graph illustrating half-power frequency bandwidths of one or more response signals over various frequency ranges, wherein each response signal is derived from one or more narrow predetermined frequency bands of the elicitation signal in FIG. 4 which are reflected from an object having one or more reflectors, such as the second object in FIG. 2;

FIG. 6 is a block diagram of a hardware system for deploying responsive devices in a vehicle in anticipation of a collision with an object, wherein the system includes a global positioning system (GPS) device as compared to the system of FIG. 1;

FIG. 7 is an illustration of a vehicle having the system of FIG. 6 onboard, where the vehicle faces a potential collision with an object, for example, a bridge abutment;

FIG. 8 is a flow diagram of a method for deploying responsive devices in a vehicle in anticipation of a potential collision with an object, where the method is implementable with the system of FIG. 6; and

FIG. 9 is a flow diagram of a method for deploying responsive devices in a vehicle in anticipation of a collision with an object, where the method is implementable with the system of FIG. 6 and is an alternative to the method of FIG. 8.

### DESCRIPTION OF THE INVENTION

Exemplary embodiments of the present invention provide a method and system for deploying responsive devices in a vehicle, such as an automobile, in anticipation of a potential collision with an object. The type of object may include, for example, a large tree, a small tree, a mailbox, a sign, a fire hydrant, a post, a pole, a fence, a guardrail, a building structure, or another vehicle. In deploying vehicle responsive devices, the present invention anticipates an imminent or nearly imminent potential collision with an object so that vehicle responsive devices may be activated, deployed, or pre-armed. In addition, the nature, or type, of the object may be identified so that potential collision severity can be predicted and so that individual vehicle responsive devices can be selectively deployed based on predicted collision severity.

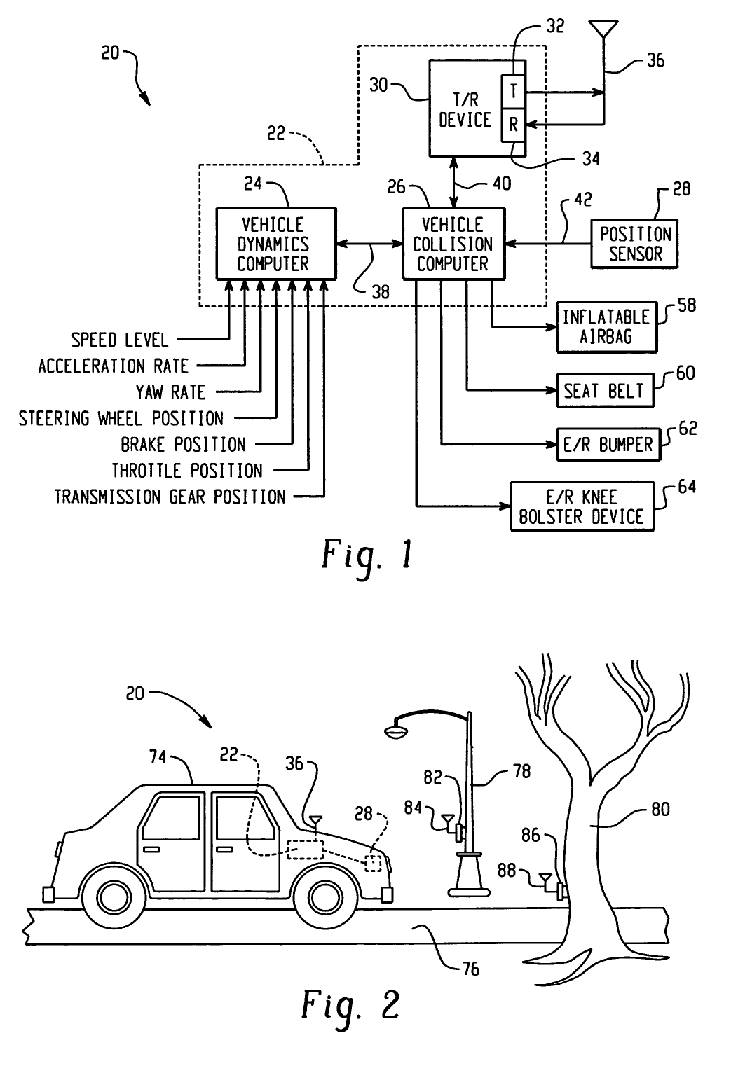

FIG. 1 is a block diagram of a basic hardware system 20 for deploying responsive devices in a vehicle in anticipation of a collision with an object. The hardware system 20 includes a position sensor 28 and a computer assembly 22. The position sensor 28 is utilized to determine the real time position of an object relative to the vehicle. The sensor 28 utilizes any technology (or combination of technologies) for determining the presence of objects, including, but not limited to: ultra wide-band radar, pulsed radar, continuous wave radar, near radar, far radar, lidar vision and image processing, near and far infrared systems, short range sensors, mid range sensors and long range sensors. In exemplary embodiments of the present invention, the sensor 28 is designed, such that if it survives a collision, it retains the ability to detect a second subsequent impact. The collision-sensing system itself should be capable of measurements in the near range of zero to at least twenty meters, preferably more, for use in assessing potential collision severity.

The sensor 28 is preferably situated at or near the lateral perimeter of the vehicle to thereby facilitate optimal line-of-sight position sensing when an object comes close to the vehicle perimeter. Although only one position sensor 28 is illustrated in FIG. 1, it is to be understood that multiple position sensors may be situated at various different points along the perimeter of the vehicle to thereby facilitate the sensing of an object approaching from any direction.

Alternative exemplary embodiments of the present invention utilize one or more sensors 28 that cover a full three hundred and sixty degrees around the vehicle to cover all possible angles of approach. In addition to increasing visibility to possible potential collisions, this may also be utilized to coordinate the deployment of vehicle responsive devices for the predicted impacts. When possible impacts involving multiple objects are detected as being imminent or nearly imminent, the individual impact events may be ordered in terms of predicted timing and severity. A prioritization selection process is then utilized to deploy those vehicle responsive devices determined to have the greatest overall effect. Other embodiments include deploying vehicle responsive devices early which may allow them to be deployed less aggressively. Vehicle responsive devices may also be deployed for a longer period of time than in events in which only a single impact is predicted, in order to cover the full duration of the multiple impacts. Further, additional vehicle responsive devices may be armed (i.e., a control set on the device) and/or extra deployment capacity may be reserved to cover instances where there is a possibility of a second impact subsequent to, and possibly resulting from, the occurrence of the first impact.

In addition, the prediction capability may be extended to predicting the vehicle trajectory after impact and thus the prediction of additional subsequent impacts (including for example a rollover) resulting from the change in trajectory due to the first impact. For example, calculation of the potential collision related change in vehicle trajectory is within the capability of commercially available accident reconstruction programs.

Referring to FIG. 1, the computer assembly 22 includes a vehicle dynamics computer 24, a transmitter/receiver (T/R) device 30, and a vehicle collision computer 26. The vehicle dynamics computer 24 is dedicated to processing dynamics data for the vehicle. Such dynamics data may include, but is not limited to, real time data concerning the speed level, the acceleration rate, the yaw rate, the steering wheel position, the brake position, the throttle position, the number of occupants, the number of belted occupants, the mass of the occupants, the loaded mass of the vehicle, the tire inflation pressure, the tire wear state, the driver demanded throttle and torque, the road friction, the anti-lock brake system (ABS) operation, the vehicle stability enhancement system (VSES) operation, the braking pressure, the amount of vehicle pitch and roll, the vehicle heading, the engine status, and/or the transmission gear position of the vehicle. The dynamics data may be utilized to perform vehicle path prediction. For example, the steering wheel position and the yaw rate in combination with the vehicle speed, and/or the GPS data in conjunction with a map preview application (located onboard the vehicle or remote to the vehicle) may be utilized to predict the path of the vehicle. As illustrated in FIG. 1, such real time data is communicated from various vehicle sensors and/or systems (not shown) to the vehicle dynamics computer 24 via electrical conductor connections.

The T/R device 30 of the computer assembly 22 includes both a transmitter 32 and a receiver 34 which are electrically connected to a directional-type antenna 36. The transmitter 32 may be implemented by a transmitter such as a wideband radio-frequency type transmitter capable of transmitting, via the antenna 36, electromagnetic radio-frequency (RF) signals over a wide band of signal frequencies. The directional antenna 36 is used for both directing and transmitting an electromagnetic radio-frequency signal to the object and also for receiving a signal from the object. During transmission, the directional antenna 36 produces a substantially unidirectional radiation pattern which is directed toward the object. It is to be understood, however, that two separate antennas, one dedicated for directional transmission and one dedicated for receiving, may alternatively be used instead of the single directional antenna 36. In exemplary embodiments of the present invention, the T/R device 30 is designed, such that if it survives a collision, it retains the ability to communicate in the event of a second subsequent impact.

The vehicle collision computer 26 of the computer assembly 22 is dedicated to predicting the severity level of any imminent or nearly imminent potential collision between the vehicle and an object so that vehicle responsive devices can be selectively deployed according to the predicted severity level. To facilitate such predicting, the vehicle collision computer 26 is electrically connected to the vehicle dynamics computer 24 via electrical conductor connection 38, electrically connected to both the transmitter 32 and the receiver 34 of the T/R device 30 via electrical conductor connection 40, and electrically connected to the position sensor 28 via an electrical conductor connection 42. As illustrated in FIG. 1, deployable responsive devices onboard the vehicle may include an inflatable airbag 58, a pre-tensionable seat belt 60, an expandable/retractable bumper 62, and/or an expandable/retractable knee bolster device 64. Such vehicle responsive devices are electrically connected to the vehicle collision computer 26 via electrical conductor connections so that each vehicle responsive device can be selectively and timely deployed as deemed necessary by the vehicle collision computer 26. Any of the electrical conductor connections described herein may be a wireless connection and/or a physical connection.

In exemplary embodiments of the present invention, the dynamics data for the vehicle is sent from the vehicle dynamics computer 24 to the vehicle collision computer 26 for use in determining if the probability of a potential collision between the vehicle and an object is over a threshold value. The threshold value may be pre-selected or varying based on driver, environmental and/or vehicle characteristics. The probability being over the threshold indicates that a collision is imminent or nearly imminent. If the probability of the potential collision is over the threshold value, then the vehicle collision computer 26 generates an elicitation or interrogation signal via the T/R device 30 to initiate communication with the object.

An exemplary embodiment of the present invention is a method of predicting the severity of a potential collision of a vehicle and an object. A probability of a potential collision is compared to a threshold value to determine, or detect, when the probability of the potential collision is greater than the threshold value. The determination is made by the vehicle collision computer 26 in response to input data from the T/R device 30, the position sensor 28 and the vehicle dynamics computer 24. The threshold value may be a threshold representing an imminent potential collision, a nearly imminent potential collision or alternatively that an object is within a pre-selected or varying radius of the vehicle. In an exemplary embodiment of the present invention, a potential collision is imminent when the estimated percentage chance, or probability, that the potential collision will occur is greater than a first threshold value (e.g., 90%, 99%, 99.9%) and the potential collision is nearly imminent when the probability is greater than a second threshold value (e.g., 70%, 80%, 90%).

By determining if a potential collision is nearly imminent, the amount of lead-time between the prediction of a potential collision and the actual collision may be increased. This may allow for more actions to be taken to mitigate the impact of the potential collision, but may also lead to a greater number of false collision predictions (i.e., more instances where the collision does not occur after being predicted). The determination that a potential collision is nearly imminent may be utilized by the vehicle collision computer 26 to prepare vehicle responsive devices for the possibility of a potential collision. Based on knowledge about the nearly imminent potential collision (e.g., predicted severity, possible places of impact), controls on vehicle responsive devices may be set to particular values (e.g., select airbag inflation level) and/or deployed (e.g., change knee bolster position) in response to receiving the prediction of a nearly imminent potential collision. Additional reversible protection devices and irreversible protection devices may then be deployed when (and if) a determination is made that the potential collision is imminent. This may be implemented by having more than one threshold value with different events occurring based on which threshold value has been exceeded by the probability of the potential collision. Any implementation that allows different actions to be initiated based on the probability of the potential collision may be utilized by exemplary embodiments of the present invention.

Various algorithms may be utilized to determine the probability of the potential collision occurring. The probability of the potential collision increases as the distance between the vehicle and an object decreases and as the estimated time until the potential collision decreases. Input to calculating the probability includes data collected by the vehicle dynamics computer 24 as well as position sensor 28 data. Input to calculating the probability may also include driver state data such as the estimated alertness of the driver, the attentiveness of the driver (e.g., is driver tuning radio and/or talking on a phone) and the gaze direction of the driver. The probability of the potential collision may be increased or decreased based on the driver state data. In addition, the probability of the potential collision may be increased or decreased based on environmental data. Any data that is available to the vehicle collision computer 26 may be utilized in calculating the probability. Input to determining that the probability of the potential collision is greater than the threshold value may include the probability of the potential collision occurring and/or a rate of change of the probability of the potential collision occurring. A high rate of change (increase) of the probability may indicate that the potential collision is imminent or nearly imminent. In addition, it may be determined that the probability is greater than the threshold value if the vehicle is less than a particular distance from an object, and/or the estimated time until the potential collision is less than a pre-determined amount of time.

As described previously, data from the vehicle dynamics computer 24 may include data such as tire inflation pressure, tire wear state, road friction, anti-lock brake system operation, vehicle stability enhancement system operation, braking pressure, amount of vehicle pitch and roll, yaw, engine status, engine operation data, environmental data, and any other available information that could be useful to predicting the severity or probability of a potential collision. Environmental data may include information such as time of day, outside air temperature, current weather conditions, rain, and slush covered pavement surface. Time of day may be utilized to indicate whether the outside light level is daylight, nighttime or dusk.

In addition, the vehicle responsive devices may be controlled based on driver and/or passenger (front and back) characteristics such as position, size, weight and seat belt buckle status. In an alternate exemplary embodiment of the present invention, the estimated probability of the potential collision may be broadcast to other vehicles within a pre-specified radius or to a mobile application service (e.g., an ONSTAR system that is commercially available from General Motors Corporation, where ONSTAR is a registered trademark of General Motors Corporation) to alert them of the impending potential collision.

Exemplary embodiments of the present invention may be modified to utilize Federal Communications Commission (FCC) approved bands for vehicle to object communication and for vehicle to infrastructure communication.

FIG. 2 is an illustration of a vehicle 74 having the system 20 of FIG. 1 onboard as the vehicle 74 travels along a drive path 76. The system 20 is attachable to and/or integrable with the structure of the vehicle 74. As illustrated, the vehicle 74 faces potential collisions with a first object and a second object, in this particular case, a street lamppost 78 and a tree 80.

With regard to the lamp post 78 as a first potential object of collision, the system 20 in this particular case includes an active transponder 82 with an antenna 84 situated and mounted on the lamppost 78. The transponder 82 is basically a small microprocessor device having a receiver circuit and a transmitter circuit electrically connected to the antenna 84. Except for the antenna 84, the microprocessor device of the transponder 82 is enclosed within a small protective box or container mounted on the object, in this case, the lamppost 78. Although the microprocessor device may operate with electrical power derived from the same power source used to illuminate the lamp light in the lamp post 78, the microprocessor device is preferably powered by rechargeable batteries which are periodically charged with an external energy collector such as, for example, a solar collector.

During operation, if the vehicle 74 veers away from the drive path 76 and moves toward the lamp post 78 such that the lamp post 78 comes within a predetermined sensing range (for example, 20 meters) of the sensor 28 onboard the vehicle 74, then the sensor 28 will sense the real time position of the lamp post 78 relative to the vehicle 74 and communicate real time object position data to the vehicle collision computer 26 of the computer assembly 22 via connection 42. At generally the same time, relevant real time vehicle dynamics data from the vehicle dynamics computer 24 is communicated to the vehicle collision computer 26 via connection 38. Using both the real time object position data and the real time vehicle dynamics data, the vehicle collision computer 26 then determines if the probability of a collision between the vehicle 74 and the lamp post 78 is over a threshold value.

If the probability of a collision is over the threshold value, the vehicle collision computer 26 initiates an elicitation or interrogation signal via connection 40 within the T/R device 30 such that the elicitation signal is directed and transmitted via the transmitter 32 and the directional antenna 36 toward the lamp post 78. The elicitation signal, as transmitted from the antenna 36, is an electromagnetic, modulated radio-frequency type signal which has a wide frequency bandwidth. In general, the same elicitation signal is transmitted to each object with which the vehicle 74 faces an imminent or nearly imminent collision. The elicitation signal generally serves to prompt an object, in this case, the lamp post 78, to provide information which will positively identify the nature, or type, of the object to the vehicle 74. Alternatively, or in addition, to providing a type, the object may provide actual object size data that may be utilized in determining a predicted severity. The directional nature of the antenna 36 helps ensure that the elicitation signal is not inadvertently transmitted to another object (for example, the tree 80) instead of, or in addition to, the lamppost 78. In this way, only the object with which a potential collision is imminently or nearly imminently is prompted for positive identification information of the object type.

After transmission via the directional antenna 36, the elicitation signal is then received by the antenna 84 and the receiver circuit of the transponder 82 which is mounted on the lamppost 78. Once the elicitation signal is received, a response signal is immediately initiated and transmitted from the transmitter circuit and the antenna 84 of the transponder 82 toward the vehicle 74. The response signal, as transmitted from the antenna 84, is an electromagnetic radio-frequency type signal having a narrow, predetermined bandwidth of signal frequencies. This object-type-specific predetermined response signal generally serves to provide the vehicle 74 with information which positively identifies the nature, or specific type, of the object. More particularly, the predetermined frequency bandwidth of the response signal transmitted from the lamp post 78 serves to positively identify the first object (the lamp post 78) as a particular object type (i.e., as a lamp post). Alternatively, or in addition, to providing a type, the object may provide actual object size data that may be utilized in determining a predicted severity. According to the present invention, in other situations involving other types of objects, different objects will transmit different response signals having different narrow, predetermined frequency bandwidths. In this way, each object is differentiated and positively identified by the vehicle 74 according to object type by the particular frequency bandwidth of the respective response signal produced by the object.

After being transmitted from the transponder 82 mounted on the lamppost 78, the response signal is received by the antenna 36 and the receiver 34 of the T/R device 30 onboard the vehicle 74. The receiver 34 includes at least one electronic filter circuit for processing the response signal to thereby obtain information positively identifying the type of object from the response signal in the form of a predetermined digital code. Once obtained, the predetermined digital code is communicated to the vehicle collision computer 26 via connection 40. When the predetermined digital code is received by the vehicle collision computer 26, object-type-specific object size data which is pre-stored in a memory associated with the vehicle collision computer 26 is looked up and accessed by the vehicle collision computer 26 by using the predetermined digital code. The object size data for a particular type of object may include, for example, data relating to one or more of the width, height, depth, or mass of the object.

Once the object-specific object size data is obtained, the vehicle collision computer 26 then uses and processes known vehicle size data, real time vehicle dynamics data communicated from the vehicle dynamics computer 24, real time object position data communicated from the sensor 28, and the obtained object size data to predict the degree of severity or the severity level of the identified imminent or nearly imminent collision between the vehicle 74 and the lamp post 78.

The known vehicle size data used in determining the severity level may include, for example, data relating to one or more of the width, height, depth, or mass of the vehicle 74. When a frontal impact is predicted, the relevant vehicle size data may include data such as front bumper height, vehicle height, height of the vehicle center of gravity, frame height, and the load distribution on the face of a rigid barrier in a frontal impact, where the load distribution is determined based on a simulation or actually measured in a crash test. When a rear impact is predicted, the relevant vehicle size data may include data such as rear bumper height, vehicle height, height of the vehicle center of gravity, frame height, and the load distribution on the face of a rigid barrier in a rear impact, where the load distribution is determined based on a simulation or actually measured in a crash test. When a side impact is predicted, the relevant vehicle size data may include data such as rocker height, door beam height, and lateral stiffness of the vehicle corresponding to an estimated bumper location of a striking vehicle, where the lateral stiffness is obtained through a simulation or actually measured in a crash test.

Once a prediction of the severity level of the imminent or nearly imminent collision is made, the vehicle collision computer 26 then selectively deploys and/or pre-sets one or more responsive device onboard the vehicle 74 according to the predicted severity level. That is, in other words, depending upon the predicted severity level, the vehicle collision computer 26 then decides, for each individual vehicle responsive device, whether or not the vehicle responsive device will be pre-set (i.e. controls set on the device) and/or deployed. In general, if the predicted severity level is high, then the vehicle collision computer 26 is more likely to deploy most, if not all, of the vehicle responsive devices. On the other hand, if the predicted severity level is low, then the vehicle collision computer 26 is more likely to deploy fewer vehicle responsive devices. For example, if the vehicle 74 anticipates an imminent or nearly imminent collision with a building structure at fifty kilometers per hour, then the inflatable airbag 58, the pre-tensionable seat belt 60, the extendable/retractable bumper 62, and the extendable/retractable knee bolster device 64 are all likely to be deployed by the vehicle collision computer 26. In contrast, if the vehicle 74 anticipates an imminent or nearly imminent collision with a building structure at only ten kilometers per hour, then only the pre-tensionable seat belt 60 and the extendable/retractable bumper 62 are likely to be deployed by the vehicle collision computer 26.

In selectively deploying the vehicle responsive devices, the vehicle collision computer 26 selectively communicates a deploy signal to the vehicle responsive devices 58, 60, 62, and 64. For the vehicle responsive devices which are resettable, such as the pre-tensionable seat belt 60, the extendable/retractable bumper 62, and the extendable/retractable knee bolster device 64, the deploy signal serves as an activation signal for activating the vehicle responsive devices prior to collision impact. For any vehicle responsive device which is non-resettable, such as the inflatable airbag 58, the deploy signal serves as a pre-set or enabling signal for readying the activation of the vehicle responsive device upon collision impact. In a particular case where the predicted severity level of the collision is extremely high, such as in a case where the closing speed of the vehicle 74 toward a significant object as determined by the position sensor 28 is very fast, the deploy signal may instead serve as an actual activation signal for activating (in contrast to merely pre-setting or enabling) any non-resettable vehicle responsive device just prior to collision impact. If, by chance, a predicted collision fails to actually occur or if the collision is of minimal severity, the vehicle collision computer 26 then communicates deactivation signals to the resettable vehicle responsive devices after a predetermined delay time has passed from the anticipated time of collision impact.

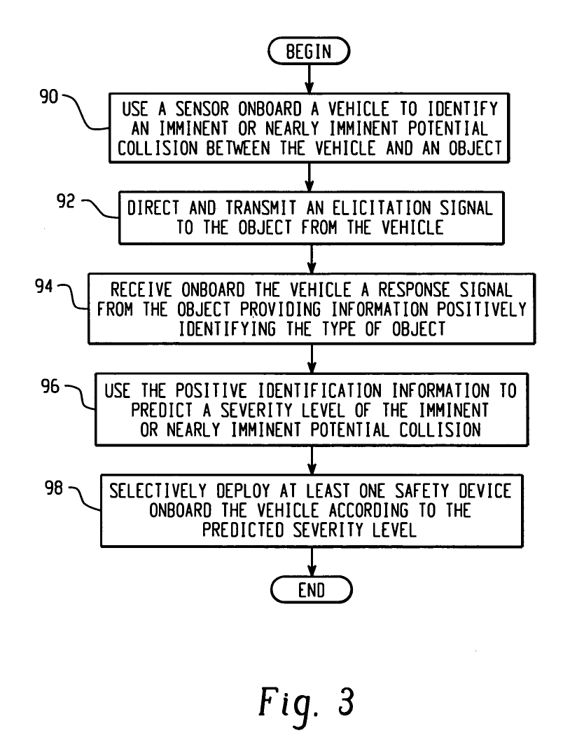

In light of the above, the method of deploying responsive devices in a vehicle in anticipation of a collision with an object, according to the present invention, can be generalized to include the process set forth in the flow diagram of FIG. 3. In particular, this includes using a sensor onboard a vehicle to identify an imminent or nearly imminent potential collision between the vehicle and an object at block 90. Next, at block 92, an elicitation signal is directed and transmitted to the object from the vehicle. The processing at block 94 includes receiving onboard the vehicle a response signal from the object providing information positively identifying the type of object. The positive identification information is used to predict a severity level of the imminent or nearly imminent potential collision at block 96 and at block 98 a vehicle responsive device is selectively deployed and/or pre-set onboard the vehicle according to the predicted severity level.

Further in FIG. 2, with regard to the tree 80 as a second potential object of collision, the system 20 in this particular case alternatively includes, instead of the active transponder 82 situated on the lamp post 78, a passive transponder or reflector 86 with an antenna 88 situated and mounted on the tree 80. The transponder or reflector 86 is passive in the sense that no integral power source is provided therewith. Although any conventional passive transponder or reflector may be incorporated in the present invention, in the case wherein a passive transponder is used instead of a reflector, the transponder is preferably of a type which includes an inductor-capacitor (LC) circuit electrically connected to the antenna 88.

Thus, during operation, if the vehicle 74 veers away from the drive path 76 and moves instead toward the tree 80 such that the tree 80 comes within the predetermined sensing range of the sensor 28, then an elicitation signal will instead be directed and transmitted toward the tree 80 when the anticipated collision between the vehicle 74 and the tree 80 is identified by the vehicle collision computer 26 and has a probability of occurring that is greater than a threshold (i.e., is imminent or nearly imminent). In the case where a reflector is situated on the tree 80, when the transmitted elicitation signal is received by the antenna 88, the reflector merely fashions a response signal having a narrow, predetermined frequency bandwidth which is object-specific from the elicitation signal having a wide frequency bandwidth. In essence, the fashioned response signal comprises a reflected, narrow bandwidth portion of the elicitation signal. Once the response signal is successfully generated or fashioned by the passive transponder or reflector 86, the response signal is sent via the antenna 88 to the vehicle 74 where the response signal is received by the antenna 36 and the receiver 34 of the T/R device 30. As explained previously herein, the receiver 34 uses at least one electronic filter circuit to process the response signal to thereby obtain information positively identifying the type of object from the response signal in the form of a predetermined digital code. Once obtained, the predetermined digital code is then communicated to the vehicle collision computer 26 for predicting collision severity and ultimately deploying vehicle responsive devices in accordance therewith.

Despite the particular exemplary collision scenario described hereinabove with regard to FIG. 2, it is to be understood that any suitable type of conventional transponder, either active or passive, or conventional reflector may be situated on a particular object and thereby serve as a means for identifying the object to a vehicle pursuant to the present invention. In exemplary embodiments of the present invention, reflector shape and surface texture, as well as other reflector characteristics may be utilized to enhance differentiation between types of objects. For example, the reflectors may be distinguished by different spatial orientations of textures and/or the textures may be different (e.g., texture of reflector may be similar to sand paper of sixty grit, one-hundred grit or one-hundred and fifty grit).

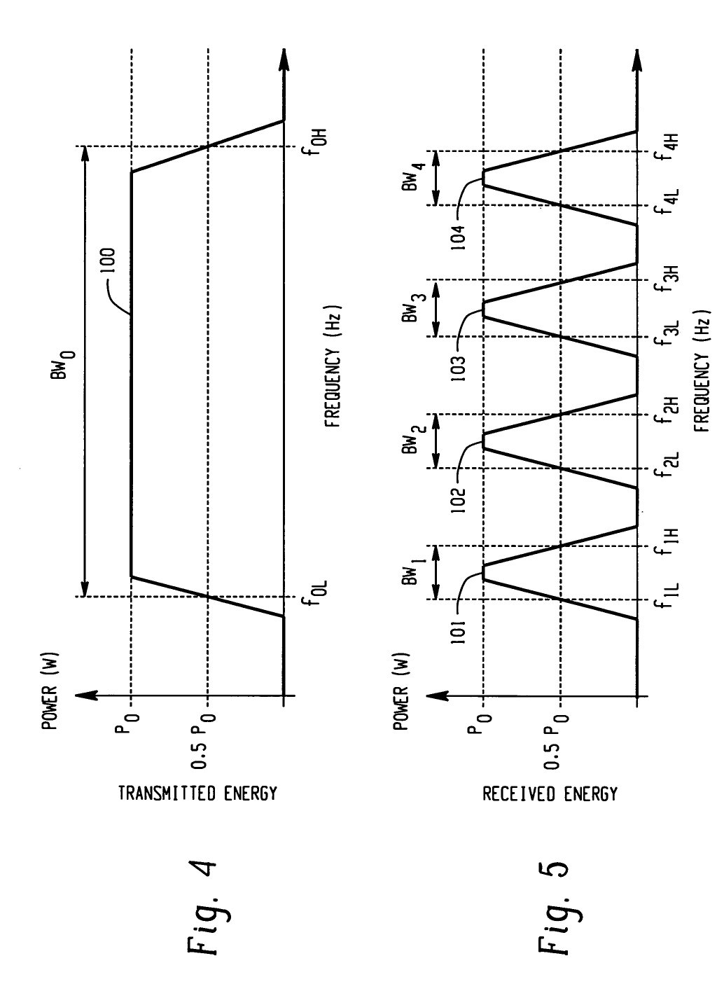

In FIG. 4, an exemplary elicitation signal 100 having a signal power P₀ over a wide band of radio frequencies is graphically illustrated. The elicitation signal 100 has a half-power frequency bandwidth BW₀ measured from a low frequency cut-off f_{0L} to a high frequency cut-off f_{0H}. In the case where a particular reflector is situated on a particular object with which a collision is imminent or nearly imminent, the reflector reflects a single, narrow, predetermined bandwidth portion of the elicitation signal 100 as a response signal back toward the vehicle. More particularly, the reflector reflects only one narrow, predetermined bandwidth portion out of many different narrow frequency bands included within the bandwidth BW₀ of the elicitation signal 100 as a predetermined response signal for positively identifying the object on which the reflector is particularly situated. Thus, each particular reflector is only capable of reflecting one particular narrow frequency band of the elicitation signal.

Examples of different response signals fashioned from the elicitation signal 100 by different reflectors on various different objects are graphically illustrated in FIG. 5. Such exemplary response signals include a response signal 101, a response signal 102, a response signal 103, and a response signal 104. Although the reflectors will absorb and/or dissipate some of the signal power P₀ of the elicitation signal 100 during reflection, each response signal fashioned and reflected from the elicitation signal 100 ideally has a signal power which approaches the same signal power P₀ of the elicitation signal 100. Thus, with further regard to the exemplary response signals illustrated in FIG. 5, the response signal 101 has a signal power which approaches P₀ and has a half-power frequency bandwidth BW₁ measured from a low frequency cut-off f_{1L} to a high frequency cut-off f_{1H}, and the response signal 102 has a signal power which approaches P₀ and has a half-power frequency bandwidth BW₂ measured from a low frequency cut-off f_{2L} to a high frequency cut-off f_{2H}. Similarly, the response signal 103 has a signal power which approaches P₀ and has a half-power frequency bandwidth BW₃ measured from a low frequency cut-off f_{3L} to a high frequency cut-off f_{3H}, and the response signal 104 has a signal power which approaches P₀ and has a half-power frequency bandwidth BW₄ measured from a low frequency cut-off f_{4L} to a high frequency cut-off f_{4H}. Given such, the low frequency cut-off f_{1L} of the response signal 101 should generally be equal to or greater than the low frequency cut-off f_{0L} of the elicitation signal 100, and the high frequency cut-off f_{4H} of the response signal 104 should generally be less than or equal to the high frequency cut-off f_{0H} of the elicitation signal 100.

Thus, in practice, each one of the particular response signals illustrated in FIG. 5 would serve to provide object-specific information for positively identifying the type, or nature, of a particular object with which a vehicle faces an imminent or nearly imminent collision. For example, a reflector specifically designed to send the predetermined response signal 101 may be mounted on an object which is a highway guardrail so as to positively identify the object as a guardrail-type object with the particular response signal 101 to a vehicle. Similarly, another reflector specifically designed to send the predetermined response signal 102 may be mounted on an object which is a telephone pole so as to positively identify the object as a pole-type object with the particular response signal 102 to a vehicle. In this way, different response signals are used to positively identify different types or classes of objects to a vehicle. It is to be understood, however, that a single object may alternatively have multiple different reflectors mounted thereon at the same time which reflect different signals. In this way, a unique combination of different signals is used to form a composite response signal to identify the type of each object. As a result, composite response signals can be encoded to thereby facilitate the positive identification of a larger number of different object types in response to an elicitation signal of a given fixed bandwidth. As an additional result, using a unique combination of different signals in the form of a composite response signal to identify an object helps prevent the misidentification of the object, which is more likely to occur when only a single band response signal is used to identify an object. Furthermore, when multiple different reflectors are used to identify a single object in this way, such reflectors may either be situated separately on the object or be integrated into a single composite reflector unit on the object.

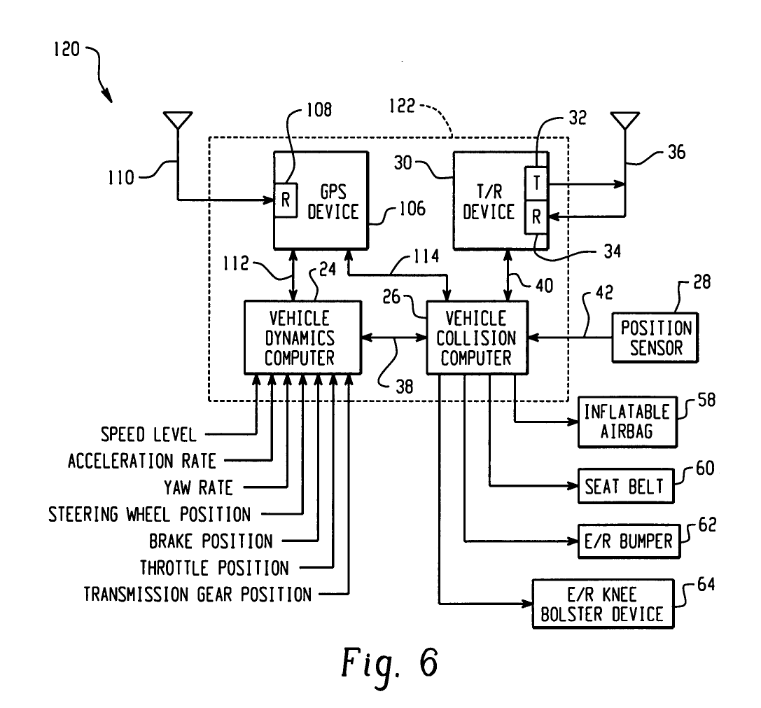

FIG. 6 is a block diagram of an alternative hardware system 120 for deploying responsive devices in a vehicle in anticipation of a collision with an object. Similar to the basic hardware system 20 in the previous embodiment, the hardware system 120 in the present embodiment includes the position sensor 28 and a computer assembly 122. As compared to the previous embodiment, the computer assembly 122 in the present embodiment uniquely includes a global positioning system (GPS) device 106 in addition to the vehicle dynamics computer 24, the transmitter/receiver (T/R) device 30, and the vehicle collision computer 26. The GPS device 106 is used in conjunction with a large database of detailed road and highway map information in the form of digital map data. The digital map data may be stored in the GPS device 106 or stored remotely from the vehicle 74 and accessed by the GPS device 106.

Incorporating the GPS device 106 within the computer assembly 122 of the hardware system 120 is desirable for at least the following two reasons. First, the GPS device 106 enables a vehicle to obtain real time vehicle position data (for example, longitude and latitude) from at least one (for example, three) GPS satellite to thereby help precisely determine where the vehicle is positioned on or near a particular roadway. Second, recent advances in GPS technology have now yielded GPS devices utilizable with digital map data containing very detailed information concerning both the identity and position of various objects situated along or near roadways. Some of these objects may include, for example, signs, poles, fire hydrants, barriers, bridges, bridge pillars, and overpasses. In addition, the digital map data utilized with and/or provided by such recent GPS devices is easily updateable via remote transmissions (for example, via a cell phone) from GPS customer service centers so that detailed information concerning both the identity and position of even temporary signs or blocking structures set up during brief periods of road-related construction is available as well. Thus, by incorporating the GPS device 106 in the computer assembly 122 of the hardware system 120 onboard a vehicle, the hardware system 120 then has additional means, as compared to the system 20 in the first embodiment, for positively identifying the type of an object with which the vehicle anticipates an imminent or nearly imminent collision.

Further in FIG. 6, the GPS device 106 includes a receiver 108 and an antenna 110 for obtaining real time vehicle position data from a global positioning system satellite. As illustrated, the GPS device 106 is electrically connected to the vehicle dynamics computer 24 via electrical conductor connection 112 and is electrically connected to the vehicle collision computer 26 via electrical conductor connection 114 to thereby provide the vehicle dynamics computer 24 and the vehicle collision computer 26 with access to the real time vehicle position data and the digital map data. It is to be understood, however, that one of the direct connections, either 112 or 114, from the GPS device 106 may alternatively be omitted since any vehicle position data and/or digital map data which is directly accessed via the one remaining direct connection can be optionally shared by the vehicle dynamics computer 24 and the vehicle collision computer 26 via the connection 38.

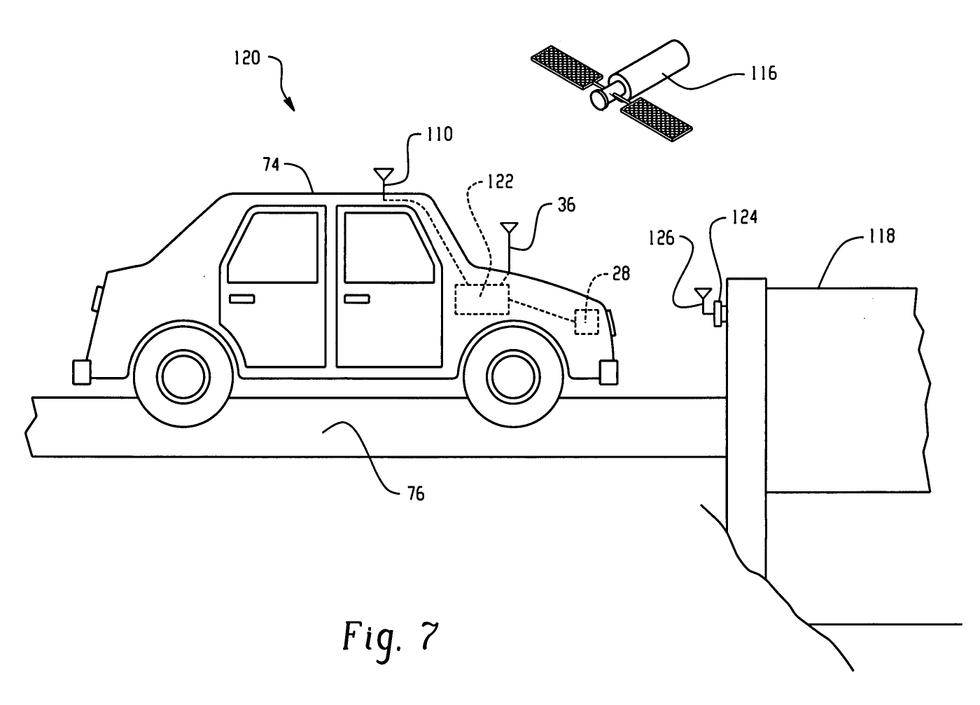

FIG. 7 is an illustration of the vehicle 74 alternatively having the system 120 of FIG. 6 onboard as the vehicle 74 travels along the drive path 76. The system 120 is attachable to and/or integrable with the structure of the vehicle 74. As illustrated in FIG. 7, the vehicle 74 faces a potential collision with an object which, in this case, is an abutment of a bridge 118. With regard to the bridge 118 as a potential object of collision, the system 120 includes a reflector 124 with an antenna 126 situated and mounted on the bridge 118. As an alternative, it is to be understood that the reflector 124 in the system 120 may optionally be replaced with either an active or passive transponder.

During operation, the GPS device 106 is first activated or turned on by an operator, such as the human driver of the vehicle 74, to establish electromagnetic radio-frequency communication linkage between the vehicle 74 and at least one (for example, three) global positioning system satellite 116. In this way, real time vehicle position data from the satellite 116 is obtained via the antenna 110 and the receiver 108 of the GPS system device 106 so that the vehicle position data, along with the digital map data, can be timely communicated when necessary to the vehicle dynamics computer 24 and/or the vehicle collision computer 26 via connection 112 and/or connection 114.

Next, if the vehicle 74 veers away from the drive path 76 and moves toward the abutment of the bridge 118 such that the abutment comes within a predetermined sensing range (for example, 20 meters) of the sensor 28 onboard the vehicle 74, then the sensor 28 will sense the real time position of the abutment of the bridge 118 relative to the vehicle 74 and communicate real time object position data to the vehicle collision computer 26 of the computer assembly 122 via connection 42. At about the same time, relevant real time vehicle dynamics data from the vehicle dynamics computer 24 is communicated to the vehicle collision computer 26 as well via connection 38. Using both the real time object position data and the real time vehicle dynamics data, the vehicle collision computer 26 then predicts a time until collision impact. If the predicted time until collision impact becomes equal to or less than a predetermined imminency threshold time (i.e., the probability of a collision is greater than a threshold value), the vehicle collision computer 26 will then deem and identify the predicted collision as an imminent or nearly imminent collision.

Once an imminent or nearly imminent potential collision is identified, real time object position data provided by the sensor 28 via connection 42 and both real time vehicle position data and digital map data provided by the GPS device 106 are used by the vehicle collision computer 26 to determine whether the digital map data provides information positively identifying the type of object. If the object type is successfully positively identified based on the digital map data provided (or utilized) by the GPS device 106, then this information is used by the vehicle collision computer 26 to predict the severity level of the imminent or nearly imminent collision and to selectively deploy and/or pre-set each of the vehicle responsive devices accordingly. In this case, the object specific size data come directly from the GPS device 106 or alternatively, it may be pre-stored in a memory associated with the vehicle collision computer 26 as described previously.

If, on the other hand, the object type is not successfully positively identified based on the digital map data provided by or utilized with the GPS device 106, then the vehicle collision computer 26 initiates an elicitation signal via connection 40 so that the elicitation signal is directed and transmitted via the transmitter 32 and the antenna 36 of the T/R device 30 toward the abutment of the bridge 118. The elicitation signal is then received by the reflector 124 mounted on the abutment of the bridge 118 via the antenna 126. Once the elicitation signal is received, a response signal comprising a reflected, narrow, predetermined bandwidth portion of the elicitation signal is immediately sent from the reflector 124 via the antenna 126 toward the vehicle 74. As generally explained earlier herein with regard to the first embodiment, the predetermined frequency bandwidth of the response signal sent from the abutment of the bridge 118 enables the vehicle collision computer 26 onboard the vehicle 74 to positively identify the type of the object (i.e., a bridge) and to predict the severity of the imminent or nearly imminent collision. Once this is done, the vehicle collision computer 26 then proceeds, as also generally explained earlier herein, to selectively deploy or pre-set the vehicle responsive devices 58, 60, 62, and 64 according to the predicted severity.

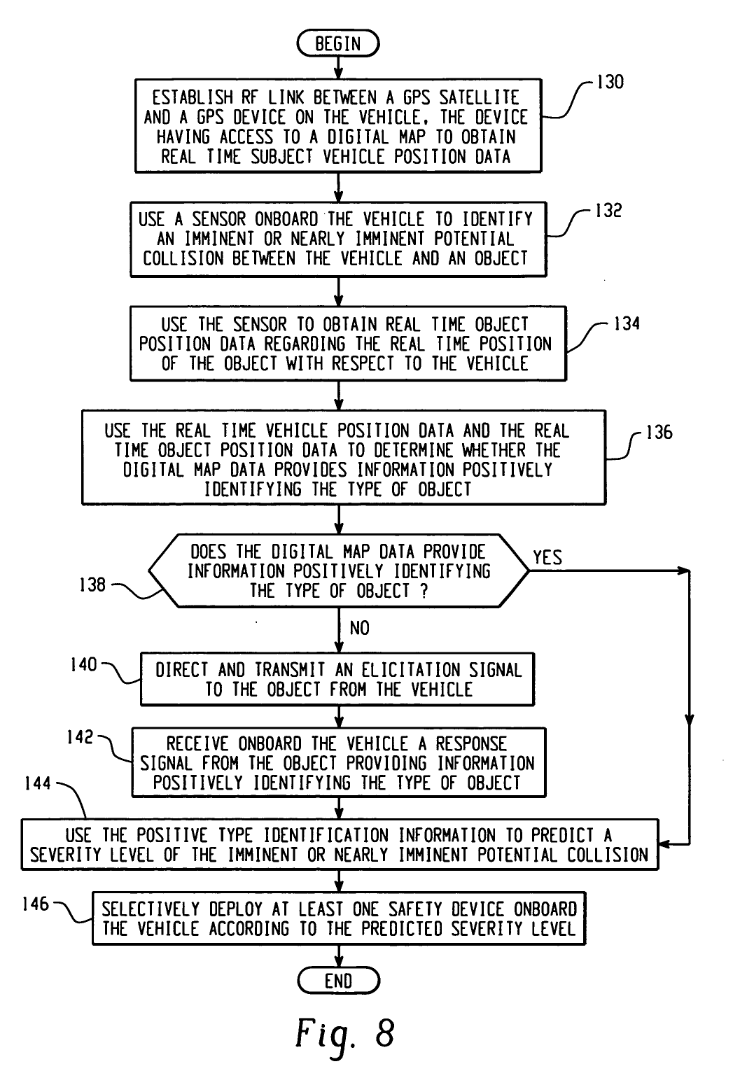

In light of the above, with regard to the system 120, the method of deploying responsive devices in a vehicle in anticipation of a collision with an object, according to the present invention, can be generalized to include the process set forth in the flow diagram of FIG. 8. The process includes: establishing electromagnetic radio-frequency (RF) communication linkage between at least one global positioning system (GPS) satellite and a GPS device having access to a digital map data (situated onboard the vehicle or outside the vehicle) to obtain real time vehicle position data from the satellite for use onboard the vehicle at block 130; using a sensor onboard the vehicle to identify an imminent or nearly imminent collision between the vehicle and an object at block 132; using the sensor to obtain real time object position data regarding the real time position of the object with respect to the vehicle at block 134; and using the real time vehicle position data and the real time object position data to determine whether the digital map data provides information positively identifying the type of the object at block 136. According to the question at block 138, if the digital map data does not provide information positively identifying the object, then both directing and transmitting an elicitation signal to the object from the vehicle at block 140 and receiving onboard the vehicle a response signal from the object providing information positively identifying the object at block 142 are performed before the processing in block 144 is performed. On the other hand, if the digital map data does provide information positively identifying the type of object, then blocks 140 and 142 are skipped, and block 144 is performed after block 138. After obtaining positive type identification information concerning the object, whether the information was obtained from digital map data or received via a response signal from the object itself, the positive type identification information is used to predict a severity level of the imminent or nearly imminent collision at block 144. At block 144, a responsive device onboard the vehicle is deployed or pre-set according to the predicted severity level.

With further regard to the method in FIG. 8, it should be noted that blocks 132 and 134 are closely related and may alternatively be executed separately, in the reverse order, or even executed simultaneously such that the very same real time object position data obtained by the sensor 28 is used both for identifying an imminent or nearly imminent potential collision and for trying to obtain object type identification information from the digital map data. In addition, it should also be noted that the particular method in FIG. 8 dictates that an elicitation signal not be transmitted to an object when the object is successfully positively identified with digital map data provided by the GPS device 106. That is, an elicitation signal is only transmitted to an object when the object is not successfully identified with the digital map data provided by the GPS device 106.

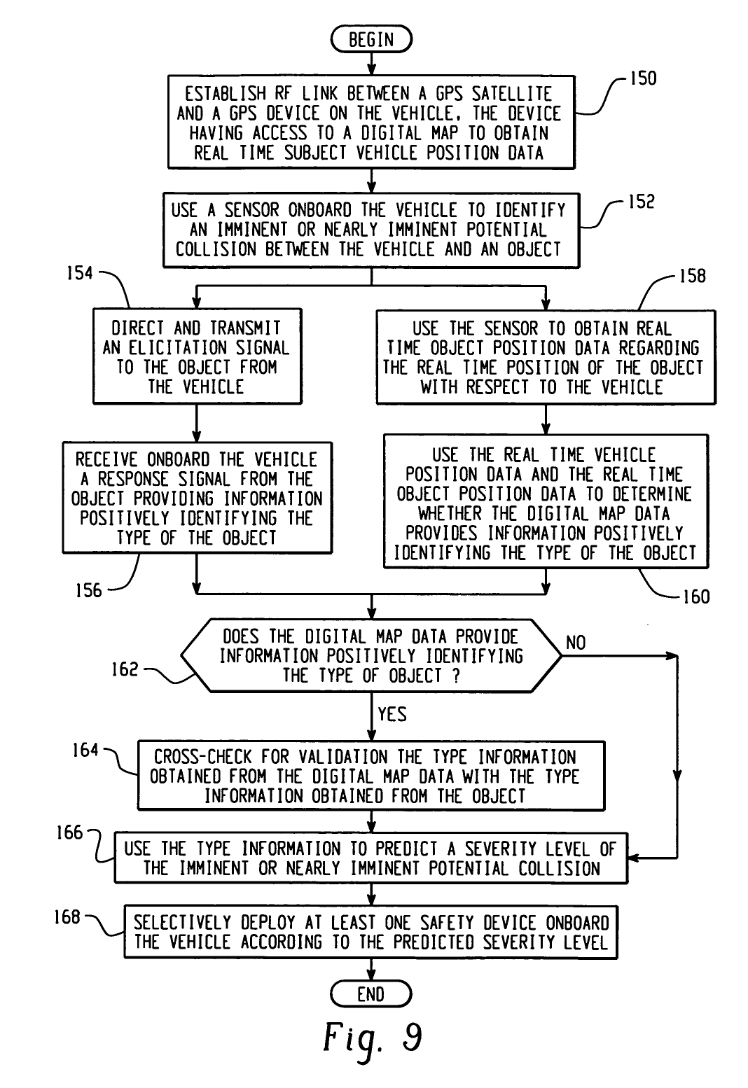

In contrast to the method in FIG. 8, the flow diagram in FIG. 9 sets forth a slightly different method of deploying and/or pre-setting responsive devices in a vehicle in anticipation of a collision with an object. In particular, according to the method of FIG. 9, an elicitation signal is always transmitted to an object when a potential collision therewith is imminent or nearly imminent. This is so even if the object is successfully identified with the GPS device 106. In particular, whenever information positively identifying the type of object is successfully obtained from the GPS device 106, then that information is cross-checked with identification information that is obtained from the object itself via a response signal prompted by an elicitation signal. By cross-checking object identification information in this manner, object misidentification is improved.

Referring to FIG. 9, the process includes establishing an electromagnetic radio-frequency (RF) communication linkage between at least one global positioning system (GPS) satellite and a GPS device having access to digital map data to obtain real time vehicle position data from at least one satellite for use onboard the vehicle at block 150; using a sensor onboard the vehicle to identify an imminent or nearly imminent collision between the vehicle and an object at block 152; directing and transmitting an elicitation signal to the object from the vehicle at block 154; receiving onboard the vehicle a response signal from the object providing information positively identifying the object at block 156; using the sensor to obtain real time object position data regarding the real time position of the object with respect to the vehicle at block 158; and using the real time vehicle position data and the real time object position data to determine whether the digital map data provides information positively identifying the object at block 160.

According to the question at block 162, if the digital map data does provide information positively identifying the type of object, then block 164 is performed before executing the process in blocks 166 and 168. Block 164 cross-checks, for validation, the positive type identification information obtained from the digital map data with the positive type identification information obtained from the object. If, on the other hand, the digital map data does not provide information positively identifying the type of object, then block 164 is skipped, and block 166 using the positive identification information to predict a severity level of the imminent or nearly imminent collision and block 168 selectively deploying at least one responsive device onboard the vehicle according to the predicted severity level are thereafter performed.

With further regard to the method in FIG. 9, it should be noted that blocks 154 and 156 may be executed in parallel with blocks 158 and 160. As an alternative, blocks 154, 156, 158, and 160 may instead all be serially executed in various different serial orders as long as block 154 is performed sometime before block 156 and as long as block 158 is performed sometime before block 160. Furthermore, it should also be noted that blocks 152 and 158 are closely related and may alternatively be executed separately in the reverse order or executed simultaneously such that the very same real time object position data obtained by the sensor 28 is used both for identifying an imminent or nearly imminent collision and for trying to obtain object identification information from the digital map data. However, block 152 is most preferably performed before block 154.

A method of and apparatus for predicting the severity of an imminent or nearly imminent potential collision between a vehicle and an object is described above. In an exemplary embodiment of the present invention, the prediction of severity is early enough so that the timing and extent of deployment of vehicle responsive devices can be controlled in accordance with the predicted potential collision severity and the expected time (e.g., imminent, nearly imminent) of the potential collision.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method of predicting severity of a potential collision of a vehicle and an object, the method comprising:
determining a probability of the potential collision;
directing and transmitting an elicitation signal to the object from the vehicle when the probability of the potential collision is greater than a threshold value;
receiving onboard the vehicle a response signal from a device situated on the object in response to the elicitation signal, the response signal including a type associated with the object; and
predicting a severity level of the potential collision responsive to the type.

2. The method of claim 1, wherein input to the determining includes sensor data collected by one or more sensors.

3. The method of claim 2, wherein the sensor data includes one or more of closing speed, range, position and angle of approach.

4. The method of claim 2, wherein at least one of the sensors provides a three hundred and sixty degree view around the vehicle.

5. The method of claim 2, wherein the sensors collect sensor data by utilizing one or more of ultra wide-band radar, pulsed radar, continuous wave radar, near radar, far radar, near and far infrared, vision and image processing, short range sensors, mid range sensors, and long range sensors.

6. The method of claim 1, wherein input to the determining includes an estimated percentage chance of the potential collision occurring.

7. The method of claim 1, wherein input to the determining includes a rate of change of an estimated percentage chance of the potential collision occurring.

8. The method of claim 1, wherein input to the determining includes an estimated percentage chance of the potential collision occurring and a rate of change of the estimated percentage chance of the potential collision occurring.

9. The method of claim 1, wherein input to the determining includes driver state data.

10. The method of claim 1, wherein the probability of the potential collision is greater than the threshold value if the vehicle is less than a selected distance from the object.

11. The method of claim 1, wherein the probability of the potential collision is greater than the threshold value if the vehicle is closing in on the object.

12. The method of claim 1, wherein the probability of the potential collision is greater than the threshold value if an estimate of time until the potential collision is less than a selected time period.

13. The method of claim 1, wherein the threshold value indicates that the potential collision is imminent.

14. The method of claim 1, wherein the threshold value indicates that the potential collision is nearly imminent.

15. The method of claim 1, wherein the predicting the severity of the potential collision includes estimating the order of potential collision occurrence when potential collisions with more than one object are predicted.

16. The method of claim 1, wherein the predicting the severity of the potential collision includes estimating vehicle trajectory after the potential collision.

17. The method of claim 1, wherein the predicting the severity of the potential collision is includes estimating a location of impact on the vehicle.

18. The method of claim 1, wherein the predicting the severity is further responsive to vehicle dynamics data.

19. The method of claim 18, wherein the vehicle dynamics data includes one or more of tire inflation pressure, tire wear state, road friction, anti-lock brake system operation, vehicle stability enhancement system operation, braking pressure, amount of vehicle pitch and roll, amount of vehicle yaw, environmental data, engine status, and engine operation data.

20. The method of claim 18, wherein the vehicle dynamics data includes one or more of number of occupants, number of belted occupants, mass of occupants, and loaded mass of vehicle.

21. The method of claim 18, wherein the vehicle dynamics data includes path prediction data, said path prediction data including one or more of steering wheel position, yaw rate, vehicle speed, vehicle position data and map preview data, wherein the vehicle position data and map preview data are determined onboard the vehicle or through telematics.

22. The method of claim 1, further comprising transmitting a command to set a control on a responsive device on the vehicle when the probability of the potential collision is greater than the threshold value, said command responsive to the severity of the potential collision for the vehicle.

23. The method of claim 1, further comprising transmitting a command to deploy a responsive device on the vehicle when the probability of the potential collision is greater than the threshold value, the command responsive to the severity of the potential collision for the vehicle.

24. The method of claim 23, wherein the command is further responsive to one or more of driver position, driver size, driver weight, and driver seat belt buckle status.

25. The method of claim 23, wherein the command is further responsive to one or more of passenger position, passenger size, passenger weight, and passenger seat belt buckle status.

26. The method of claim 1, further comprising transmitting a command to a responsive device, the command responsive to the probability of the potential collision.

27. The method of claim 1, wherein the directing and transmitting is performed via one or more of ultra wide-band radar, pulsed radar, continuous wave radar, near radar, far radar, near and far infrared, vision and image processing, short range sensors, mid range sensors, and long range sensors.

28. The method of claim 1, wherein the elicitation signal is an electromagnetic, modulated radio-frequency type signal having a wide frequency bandwidth.

29. The method of claim 1, wherein the response signal is an electromagnetic radio-frequency type signal having at least one narrow frequency bandwidth.

30. The method of claim 1, wherein the transmitting and receiving are performed via bands approved by the Federal Communications Commission.

31. The method of claim 1, further comprising transmitting a notice of the potential collision to a mobile application service provider when the probability of the potential collision is greater than the threshold value.

32. The method of claim 1, further comprising broadcasting a notice of the potential collision to other vehicles within a radius of the first vehicle when the probability of the collision is greater than the threshold value.

33. The method of claim 1, further comprising broadcasting a notice of the potential collision to a workload estimator system when the probability of the potential collision is greater than the threshold value, wherein the workload estimator system utilizes the notice of the potential collision to focus driver attention on accident avoidance and accident mitigation measures.

34. The method of claim 1, wherein one or more of the determining, directing, transmitting, receiving and predicting are performed by a system that is remote to the vehicle.

35. The method of claim 1, wherein one or more of the determining, directing, transmitting, receiving and predicting are performed by a satellite based system that is remote to the vehicle.

36. The method of claim 1, wherein the type associated with the object is one of a small diameter tree, a large diameter tree, a mailbox, a sign, a fire hydrant, a post, a concrete filled non-breakaway metal post, a non-breakaway telephone pole, a breakaway light pole, a fence, a guardrail, a building structure, a bridge abutment, and a car.

37. The method of claim 1, wherein at least one reflector is situated on the object to reflect at least one narrow predetermined frequency band of the elicitation signal as the response signal back toward the vehicle, wherein the at least one narrow predetermined frequency band provides the information positively identifying the type associated with the object.

38. The method of claim 37 wherein the shape of the reflector is utilized to positively identify the type associated with the object.

39. The method of claim 37 wherein a texture on a surface of the reflector is utilized to positively identify the type associated with the object.

40. The method of claim 1, wherein a transponder is situated on the object to receive the elicitation signal and transmit a predetermined signal as the response signal to the vehicle, wherein the predetermined signal provides the information positively identifying the type associated with the object.

41. The method of claim 1, the method further comprising:
establishing electromagnetic radio-frequency communication linkage between at least one global positioning system satellite and a global positioning system device onboard the vehicle to obtain real time vehicle position data from the satellite for use onboard the vehicle;
using a sensor to obtain real time object position data regarding the real time position of the object with respect to the vehicle;
using the real time vehicle position data and the real time object position data to determine whether digital map data accessed by the global positioning system device provides information positively identifying the type of the object; and
cross-checking for validation any said positive type identification information obtained from the digital map data with the positive type identification information obtained from the object.

42. The method of claim 41, wherein the digital map further provides object size data.

43. A method for predicting severity of a potential collision of a vehicle and an object, the method comprising:
determining a probability of the potential collision;
establishing electromagnetic radio-frequency communication linkage between at least one global positioning system satellite and a global positioning system device onboard the vehicle to obtain real time vehicle position data from the satellite for use onboard the vehicle when the probability of the potential collision is greater than a threshold value;
using a sensor to obtain real time object position data regarding the real time position of the object with respect to the vehicle;
using the real time vehicle position data and the real time object position data to determine whether digital map data accessed by the global positioning system device provides information positively identifying the type of the object; and
predicting a severity level of the potential collision in response to the global positioning system positively identifying the type of the object, wherein input to the predicting includes the type.

44. A computer program product for predicting severity of a potential collision of a vehicle and an object, the computer program product comprising:
a storage medium readable by a processing circuit and storing instructions for execution by the processing circuit for performing a method comprising:
determining a probability of the potential collision;
directing and transmitting an elicitation signal to the object from the vehicle when the probability of the potential collision is greater than a threshold value;
receiving onboard the vehicle a response signal from a device situated on the object in response to the elicitation signal, the response signal including a type associated with the object; and
predicting a severity level of the potential collision responsive to the type.

45. An apparatus for predicting severity of a potential collision of a vehicle and an object, the apparatus comprising:
a transmitter;
a receiver; and
a microprocessor in communication with the transmitter and the receiver and including instructions for:
determining a probability of the potential collision;
directing and transmitting an elicitation signal via the transmitter to the object from the vehicle when the probability of the potential collision is greater than a threshold value;
receiving onboard the vehicle via the receiver a response signal from a device situated on the object in response to the elicitation signal, the response signal including a type associated with the object; and
predicting a severity level of the potential collision responsive to the type.

46. The apparatus of claim 45 further comprising a controller for deployment of an responsive device onboard the vehicle in accordance with the severity prediction.

47. The apparatus of claim 45 further comprising a controller for setting a control on an responsive device onboard the vehicle in accordance with the severity prediction.

48. The apparatus of claim 45 wherein the apparatus for use onboard the microprocessor is integrated with or linked to one or more of a potential collision avoidance system and a workload estimator system.

49. The apparatus of claim 48 wherein stages of operation of the microprocessor, the potential collision avoidance system and the workload estimator system include moving from tracking to potential collision avoidance to predicting the severity of the potential collision.
